(19) United States
(12) Patent Application Publication
(10) Pub. No.: US 2012/0077112 A1
(43) Pub. Date: Mar. 29, 2012

(54) FUEL TANK, HYDROGEN REMAINING LEVEL DETECTION SYSTEM, AND FUEL CELL SYSTEM

(75) Inventors: Kenji KIBUNE, Kobe-shi (JP); Takashi Yasuo, Kobe-shi (JP)

(73) Assignee: SANYO Electric Co., Ltd.

(21) Appl. No.: 13/248,999

(22) Filed: Sep. 29, 2011

(30) Foreign Application Priority Data
Sep. 29, 2010 (JP) 2010-218818
Aug. 4, 2011 (JP) 2011-171257

(51) Int. Cl. H01M 8/04; F17C 11/00; G06F 19/00

(52) U.S. Cl. 429/515; 702/55; 206/7

(57) ABSTRACT

A fuel tank comprises: multiple pellets each formed of a hydrogen storage metal which is capable of storing hydrogen to be supplied to fuel cells; a support mechanism configured to support the multiple pellets such that they are layered mutually closest to one another while still permitting the volume of the multiple pellets to change; a housing unit configured to house the multiple pellets in a layered state which is maintained by the support mechanism; and a detection unit configured to detect the positions of both ends of the multiple pellets which change due to changes in the volume of the multiple pellets.

### CROSS-REFERENCE TO RELATED APPLICATIONS

This application is based upon and claims the benefit of priority from the prior Japanese Patent Application No. 2010-218818, filed on Sep. 29, 2010 and Japanese Patent Application No. 2011-171257, filed on Aug. 4, 2011, the entire contents of which are incorporated herein by reference.

### BACKGROUND OF THE INVENTION

1. Field of the Invention

The present invention relates to a fuel tank including a hydrogen storage metal.

2. Description of the Related Art

In recent years, fuel cells have attracted attention, as they have high energy conversion efficiency and have an advantage of not producing harmful materials in electric power generation. Furthermore, a fuel tank configured as a unit to store fuel separate from the main cell body has been also proposed, which allows fuel cells to be employed in movable and portable devices.

A fuel cell system configured as a power supply for a portable device is required to have a small size and to provide high output electric power. From the high output point of view, an arrangement employing hydrogen fuel as fuel for a fuel cell is more advantageous than an arrangement employing a methanol fuel. Examples of methods for storing hydrogen fuel include a metal hydride (hydrogen storing alloy tank housing a metal hydride. As a conventional method for detecting the hydrogen storage amount (hydrogen remaining level) in such a metal hydride tank, a method is known in which the pressure (hydrogen balance pressure) in the tank is measured.

However, with such a method for estimating the hydrogen remaining level by measuring the pressure in the tank, there is low linearity in the relation between the pressure in the tank and the hydrogen remaining level. Accordingly, such a method cannot provide high-precision estimation of the hydrogen remaining level. In order to solve such a problem, a method is known in which the hydrogen remaining level in the metal hydride tank is measured by making use of the nature of the metal hydride to measure changes in the volume of the metal hydride, in that, when the metal hydride stores hydrogen, the volume of the metal hydride increases, and when it discharges the hydrogen, the volume of the metal hydride decreases.

The aforementioned method can be effectively applied to a stationary hydrogen storage tank, or a metal hydride tank mounted on a vehicle, where the attitude of the metal hydride tank is maintained at a constant level. However, in many cases, a metal hydride tank mounted on a portable device is used in conditions in which its attitude is not maintained at a constant level. The aforementioned method does not take into account changes in the attitude of the metal hydride tank. In some cases, such an arrangement leads to a problem in that a detection unit configured to detect changes in the volume of the metal hydride is blocked, and a problem in that the weight of the metal hydride displaces the springs configured to fix the metal hydride pellets, depending on the attitude of the metal hydride tank. In such cases, it is difficult to measure changes in the volume of the metal hydride with high precision.

### SUMMARY OF THE INVENTION

The present invention has been made in view of such a situation. Accordingly, it is a general purpose of the present invention to provide a technique which allows the change of the volume of a metal hydride to be calculated regardless of the attitude of the fuel tank.

In order to solve such a problem, a fuel tank according to an embodiment of the present invention comprises: multiple pellets formed of a hydrogen storage metal which is capable of storing hydrogen to be supplied to fuel cells; a support mechanism configured to support the multiple pellets such that they are layered mutually closest to one another while still permitting the volume of the multiple pellets to change; a housing unit configured to house the multiple pellets supported by the supporting mechanism such that they are layered; and a detection unit configured to detect the positions of both ends of the multiple pellets along the layering direction, which changes due to changes in the volume of the multiple pellets.

With such an embodiment, the layered state of the multiple pellets is maintained by means of the support mechanism even if the attitude of the fuel tank changes. Thus, by detecting the positions of both ends of the multiple pellets along the layering direction by means of the detecting unit, such an arrangement is capable of calculating changes in the overall volume of the multiple pellets regardless of the attitude of the fuel tank.

Also, the support mechanism may be configured as elastic members respectively arranged between one end of the multiple pellets and the inner wall of the housing unit and between the other end of the multiple pellets and the inner wall of the housing unit. Also, the elastic members may be configured to apply force to both ends of the multiple pellets. Such an arrangement is capable of maintaining the layered state of the multiple pellets while still permitting the volume of the multiple pellets to change. Furthermore, such an arrangement suppresses free movement of the multiple pellets in the housing unit.

Also, the support mechanism may be configured as an elastic member configured to connect both ends of the multiple pellets along the layering direction, and to hold both ends of the multiple pellets by applying force to both ends thereof along the layering direction. Such an arrangement is capable of maintaining the layered state of the multiple pellets while still permitting the volume of the multiple pellets to change.

Also, the support mechanism may comprise: a pair of support members configured to externally support both ends of the multiple pellets along the layering direction; and an elastic member configured to connect the pair of support members, and to hold the pair of support members by applying force along the layering direction. Such an arrangement is capable of maintaining the layered state of the multiple pellets while still permitting the volume of the multiple pellets to change.

Also, the fuel tank may further comprise a porous member introduced between adjacent pellets. Such an arrangement provides improvement in flowability on the surfaces that are in contact with the adjacent pellets.

Also, the porous member may be adhered to the pellets. Such an arrangement is capable of maintaining the layered state of the multiple pellets while still permitting the volume of the multiple pellets to change.

Also, the porous member may be formed of a porous metal. Such an arrangement provides improved thermal conductivity between the adjacent pellets and between the pellets and the fuel tank.

Also, the housing unit may comprise multiple respectively communicating cylindrical portions. Also, the multiple cylindrical portions may each house at least a hydrogen storage metal. Also, at least one of the multiple cylindrical portions may include the multiple pellets, the support mechanism, and the detection unit. Thus, by estimating changes in the volume of the multiple pellets housed in at least one of the cylindrical portions, such an arrangement is capable of estimating changes in the overall volume of the metal hydride.

Another embodiment of the present invention relates to a hydrogen remaining level detection system. The hydrogen remaining level detection system comprises: a fuel tank; and a calculation unit configured to calculate the remaining level of hydrogen stored in the housing unit based upon a signal output from the detection unit.

With such an embodiment, the remaining level of hydrogen stored in the fuel tank can be calculated regardless of the attitude of the fuel tank.

Also, the fuel tank may further comprise: a charging/discharging opening configured to allow charging with hydrogen from the outside, and discharging of hydrogen to the outside; and a storage unit configured to store information with respect to a cumulative amount of charged hydrogen. With the metal hydride, with repeated storage and discharge of hydrogen, the maximum amount of hydrogen with which the alloy can be charged tends to become smaller. Thus, by storing the information with respect to the cumulative amount of charged hydrogen, such an arrangement is capable of correcting calculation of the remaining level of hydrogen.

Also, the calculation unit may be configured to calculate the remaining level of hydrogen stored in the housing unit based upon the information with respect to the cumulative charging amount stored in the storage unit and the positions of both ends of the multiple pellets along the layering direction detected by the detection unit. Thus, the remaining level of hydrogen stored in the fuel tank can be calculated with higher precision even after the metal hydride is repeatedly subjected to hydrogen storage and discharging.

Also, the hydrogen remaining level detection system may further comprise a display unit configured to display the information with respect to the remaining level of hydrogen stored in the housing unit calculated by the calculation unit. Such an arrangement allows the hydrogen remaining level to be monitored in a simple manner.

Also, the hydrogen remaining level detection system may further comprise a hydrogen charging apparatus having a connection portion configured to be detachably connected to the charging/discharging opening, and configured to charge the fuel tank with hydrogen. Also, the calculation unit may be disposed in the hydrogen charging apparatus. Thus, such an arrangement is capable of calculating the remaining level of hydrogen without providing a calculation unit for each fuel tank, thereby contributing to a reduction in the cost of the fuel tank.

Also, the calculation unit may be configured to calculate the amount of hydrogen charged by the hydrogen charging apparatus based upon the information with respect to the positions of both ends of the multiple pellets along the layering direction detected by the detection unit. Also, the storage unit may be configured to calculate the sum of the amount of charged hydrogen thus calculated and the cumulative charging amount stored in this stage, and to store the calculation result as an updated cumulative charging amount. Thus, such an arrangement is capable of updating the cumulative amount of charged hydrogen for each fuel tank.

Yet another embodiment of the present invention relates to a fuel cell system. The fuel cell system comprises: a fuel cell unit; a fuel tank configured to store hydrogen to be supplied to the fuel cell unit; and a calculation unit configured to calculate the remaining level of hydrogen stored in the housing unit based upon a signal output from the detection unit.

With such an embodiment, the remaining level of hydrogen stored in the fuel tank can be calculated regardless of the attitude of the fuel tank.

Also, the fuel tank may further comprise: a charging/discharging opening configured to allow charging with hydrogen from the outside, and discharging of hydrogen to the outside; and a storage unit configured to store information with respect to a cumulative amount of charged hydrogen. With the metal hydride, with repeated storage and discharge of hydrogen, the maximum amount of hydrogen with which the alloy can be charged tends to become smaller. Thus, by storing the information with respect to the cumulative amount of charged hydrogen, such an arrangement is capable of correcting calculation of the remaining level of hydrogen.

Also, the calculation unit may be configured to calculate the remaining level of hydrogen stored in the housing unit based upon the information with respect to the cumulative charging amount stored in the storage unit and the positions of both ends of the multiple pellets along the layering direction detected by the detection unit. Thus, the remaining level of hydrogen stored in the fuel tank can be calculated with higher precision even after the metal hydride is repeatedly subjected to hydrogen storage and discharging.

Also, the fuel cell system may further comprise a display unit configured to display the information with respect to the remaining level of hydrogen stored in the housing unit calculated by the calculation unit. Such an arrangement allows the hydrogen remaining level to be monitored in a simple manner.

Also, the fuel cell unit may be configured to be detachably connected to the fuel tank. Also, the calculation unit may be disposed in the fuel cell unit. Thus, such an arrangement is capable of calculating the remaining level of hydrogen without providing a calculation unit for each fuel tank, thereby contributing to a reduction in the cost of the fuel tank.

It should be noted that any combination of the aforementioned components or any manifestation of the present invention may be mutually substituted between a method, an apparatus, a system, or the like, which is effective as an embodiment of the present invention.

### BRIEF DESCRIPTION OF THE DRAWINGS

FIG. 1 is a block diagram which shows a schematic configuration of a fuel cell system according to a first embodiment;

FIG. 2 is a schematic cross-sectional view of a fuel tank according to a first embodiment;

FIG. 3 is a schematic cross-sectional view of a fuel tank storing a greater amount of hydrogen than that stored in the fuel tank shown in FIG. 2;

FIG. 4 is a schematic cross-sectional view of a fuel tank according to a second embodiment;

FIG. 5 is a schematic cross-sectional view of a fuel tank according to a third embodiment;

FIG. 6 is a schematic cross-sectional view of a fuel tank housing pellets, with a porous member introduced between adjacent pellets;

FIG. 7A is a schematic diagram showing the fuel tank in an inclined condition in a state in which the housing unit houses no pellets, FIG. 7B is a schematic diagram showing the fuel tank in an inclined condition in a state in which the housing unit houses multiple pellets storing no hydrogen, and FIG. 7C is a schematic diagram showing the fuel tank in an inclined condition in a state in which the housing unit houses the multiple pellets storing hydrogen;

FIG. 8A is a schematic cross-sectional view showing a support mechanism according to a fourth embodiment, and FIG. 8B is a cross-sectional view of FIG. 8A taken along the line A-A;

FIG. 9A is a schematic cross-sectional view of a fuel tank according to a fourth embodiment, and FIG. 9B is a cross-sectional view of FIG. 9A taken along the line B-B;

FIG. 10A is a schematic side view showing a support mechanism according to a fifth embodiment, FIG. 10B is a top view showing the support mechanism shown in FIG. 10A as viewed from the direction C, and FIG. 10C is a cross-sectional view of FIG. 9A taken along the line D-D;

FIG. 11A is a schematic cross-sectional view of a fuel tank according to a fifth embodiment, and FIG. 11B is a cross-sectional view of FIG. 11A taken along the line E-E;

FIG. 12A is a schematic side view showing a support mechanism according to a sixth embodiment, and FIG. 12B is a cross-sectional view of FIG. 12A taken along the line F-F;

FIG. 13 is a diagram showing a schematic configuration of a hydrogen remaining level detection system according to a seventh embodiment;

FIG. 14 is a graph showing the relation between the number of hydrogen charging cycles and the maximum chargeable amount;

FIG. 15 is a diagram showing a schematic configuration of a hydrogen remaining level detection system according to an eighth embodiment;

FIG. 16 is a diagram showing a schematic configuration of a fuel cell system according to an eighth embodiment; and

FIGS. 17A and 17B are perspective views each showing a modification of the housing unit.

### DETAILED DESCRIPTION OF THE INVENTION

The invention will now be described by reference to the preferred embodiments. This does not intend to limit the scope of the present invention, but to exemplify the invention.

Description will be made below regarding an embodiment according to the present invention with reference to the drawings. It should be noted that the same components are denoted by the same reference symbols, and redundant description thereof will be omitted as appropriate. Each arrangement will be described for exemplary purpose only, and by no means restricts the scope of the present invention.

### First Embodiment

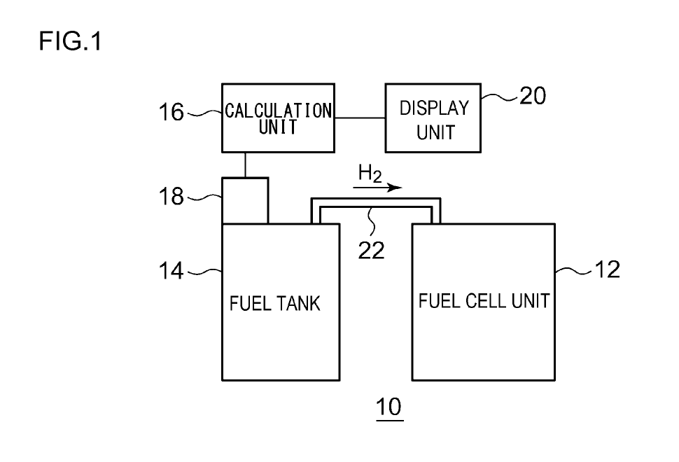

FIG. 1 is a block diagram which shows a schematic configuration of a fuel cell system according to a first embodiment. A fuel cell system 10 includes a fuel cell unit 12, a fuel tank 14 configured to store hydrogen to be supplied to the fuel cell unit, and a calculation unit 16 configured to calculate the remaining level of the hydrogen stored in the fuel tank 14. The fuel tank 14 houses a metal hydride, and includes a detection unit 18 configured to detect changes in the state of the metal hydride. The calculation unit 16 calculates changes in the volume of the metal hydride in the fuel tank 14 or the level of the remaining hydrogen based upon the signal output from the detection unit 18. The calculation result is displayed on a display unit 20 as necessary. A supply path 22 is provided between the fuel tank 14 and the fuel cell unit 12 so as to supply the hydrogen discharged from the fuel tank 14 to the fuel cell unit 12.

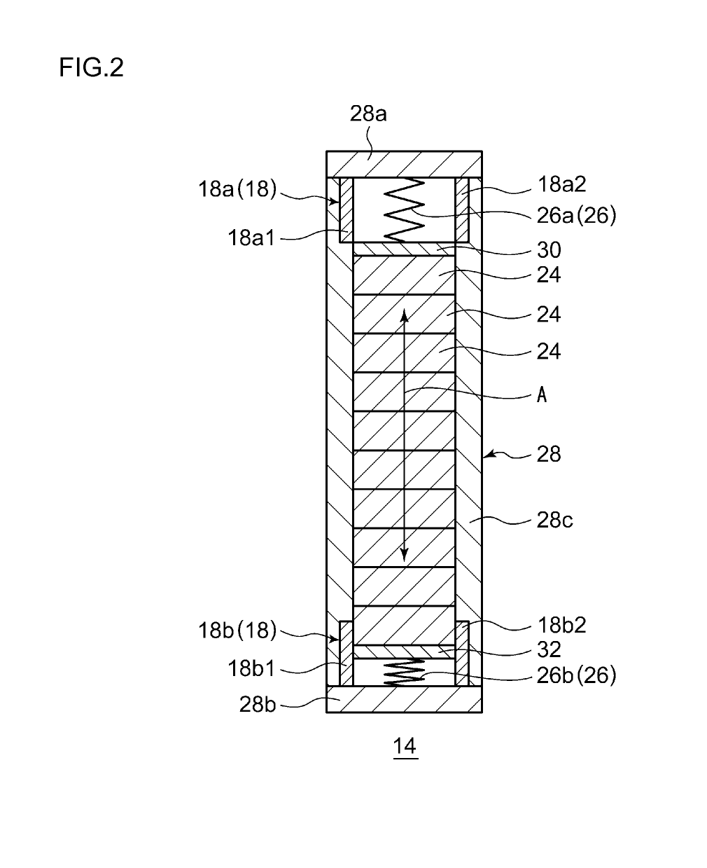

FIG. 2 is a schematic cross-sectional view of the fuel tank according to the first embodiment. The fuel tank 14 includes: multiple pellets 24 formed of a metal hydride; a support mechanism 26 configured to support the pellets 24 in a state in which they are layered such that they are mutually closest to one another while still permitting the volume of the multiple pellets 24 to change; a housing unit 28 configured to house the multiple pellets; and detection units 18 (18a and 18b) configured to detect the positions of both ends of multiple pellets 24 along the pellet layering direction, which changes due to changes in the volume of the multiple pellets 24.

Each pellet 24 is formed by mixing metal hydride powder and a binder such as a PTFE dispersion or the like, and by pressing and compacting the mixture using a pressing machine. Such a pellet 24 thus formed is capable of containing hydrogen to be supplied to the fuel cell unit 12. It should be noted that, depending on the situation, such a pellet 24 may be further subjected to sintering. The pellet is formed in the shape of a disk, in the shape of a cylinder, in the shape of a quadrangular block, or the like. The metal hydride has both a function of storing a large amount of hydrogen and a function of discharging the hydrogen thus stored. Suitable examples of such a metal hydride include LaNi₅ alloy, FeTi alloy, Mg₂Ni alloy, Ti₁₊ₓCr_{2-y} Mn_{y} (x=0.1 to 0.3, y=0 to 1.0) alloy, etc. It is the nature of such a metal hydride that, when it stores hydrogen, its volume increases, and when it discharges the hydrogen, its volume decreases.

The housing unit 28 is configured as a cylindrical or quadrangular housing, and includes a cap portion 28a and a bottom portion 28b at its respective ends in the length direction. Furthermore, a body portion 28c that connects the cap portion 28a and the bottom portion 28b is formed having a space the volume of which can change according to the hydrogen storage state of the layered multiple pellets 24. The space in which pellets are loaded may be quadrangular (in the shape of a rectangle or a slot) in cross-section with each corner having a rounded cross-section, or may be formed as a cylindrical space. The cap portion 28a, the bottom portion 28b, and the body portion 28c, are configured as separate respective units, and are each formed by machining or molding. Subsequently, the cap portion 28a and the bottom portion 28b are each fastened to the body portion 28c by means of screws or the like such that the housing unit 28 is sealed. With such an arrangement, the metal hydride is manufactured in the form of a pellet. Thus, such an arrangement avoids the effects of local stress destruction occurring in the alloy, as compared with an arrangement employing metal hydride powder.

The housing unit 28 according to the present embodiment houses the multiple pellets 24 supported by the support mechanism 26 such that they are layered. It should be noted that the housing unit 28 preferably has a quadrangular external shape, giving consideration to the heat exchange performance between it and the outside air. The housing unit 28 is preferably formed of SUS, aluminum, or the like.

The support mechanism 26 comprises two springs 26a and 26b each configured as an elastic member. The spring 26a is arranged in a compressed state such that one end is fixed to the cap portion 28a and the other end is connected to a support member 30. The spring 26b is arranged in a compressed state such that one end is fixed to the bottom portion 28b and the other end is connected to a support member 32. As described above, the two springs 26a and 26b are respectively arranged between the inner wall of the housing unit 28 and both ends of the layered multiple pellets 24 along the layering direction A, and press against the layered multiple pellets 24 from both sides along the layering direction. Such an arrangement permits the volume of the multiple pellets 24 to change while maintaining the layered state of the multiple pellets 24. Furthermore, such an arrangement suppresses migration of the multiple pellets 24 within the housing unit 28, thereby protecting each pellet from impacts due to falls or vibration of the fuel tank. Furthermore, the two springs 26a and 26b are each configured to have a length and a spring constant such that each spring is always in a compressed state regardless of the attitude of the fuel tank 14.

The pair of support members 30 and 32 is configured to support the layered multiple pellets 24 from the outside of both ends along the layering direction. By supporting the multiple pellets 24 from the outside by means of such support members 30 and 32, such an arrangement is capable of preventing the force generated by the springs 26a and 26b from being directly or locally applied to the pellets 24. In other words, the force generated by the springs 26a and 26b is uniformly applied to the pellets 24 via the support members 30 and 32. Thus, such an arrangement allows each of the pellets 24 to be stably supported in a layered state in which the pellets 24 are mutually closest to one another. Furthermore, such an arrangement inhibits cracking or chipping of each pellet 24 formed of the metal hydride.

The detection units 18a and 18b are each configured as an electrostatic capacitance sensor. Each electrostatic capacitance sensor includes a pair of electrode plates 18a1 and 18a2 (18b1 and 18b2). The pair of electrode plates 18a1 and 18a2 (18b1 and 18b2) is embedded in the inner wall of the body portion 28c of the housing unit 28 such that they face one another. Furthermore, the pair of electrode plates 18a1 and 18a2 is arranged in the vicinity of the cap portion 28a, and the pair of electrode plates 18b1 and 18b2 is arranged in the vicinity of the bottom portion 28b. The electrostatic capacitance sensor has an electrostatic capacitance that changes due to change in the volume of the support members or in the volume of the pellets that exists between the pair of the electrode plates.

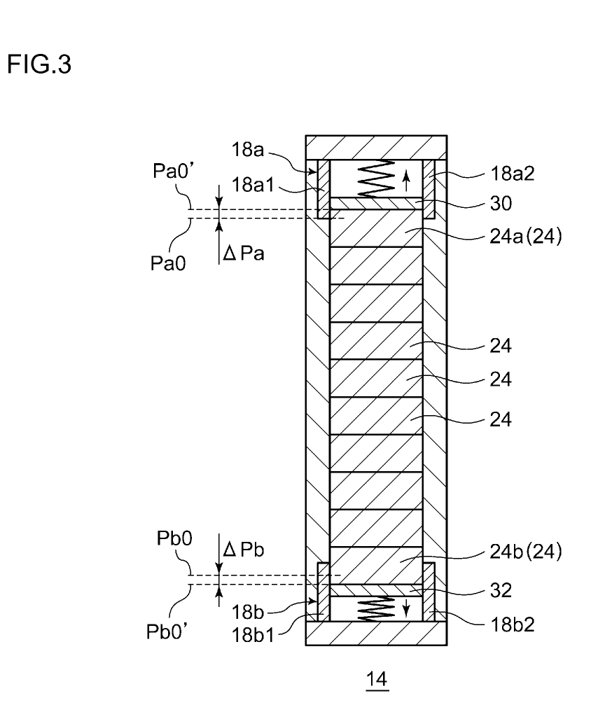

FIG. 3 is a schematic cross-sectional view of the fuel tank when it stores a greater amount of hydrogen than the fuel tank shown in FIG. 2. When the overall volume of the multiple pellets 24 changes due to absorbing or discharging hydrogen, the springs 26a and 26b expand or contract, which changes the positions of the pellets 24a and 24b positioned at the respective ends of the multiple pellets 24, and changes the positions of the support members 30 and 32. Accordingly, the electrostatic capacitance changes due to changes in the volume of the support member 30 (32) or changes in the volume of the pellets 24a (24b) arranged between the pair of electrode plates 18a1 and 18a2 (18b1 and 18b2). With such an arrangement, the detection units 18a and 18b detect the positions of the respective ends of the multiple pellets along the layering direction based upon the signal that corresponds to changes in the electrostatic capacitance.

With the fuel tank 14 according to the present embodiment, the layered state of the multiple pellets 24 is maintained by means of the support mechanism 26 even if the attitude of the fuel tank 14 changes. Thus, by detecting the positions of both ends of the multiple pellets along the layering direction by means of the detection units 18a and 18b, such an arrangement is capable of calculating changes in the volume of the multiple pellets regardless of the attitude of the fuel tank 14.

More specifically, the positions of the respective ends of the multiple pellets along the layering direction are respectively taken to be Pa0 and Pb0 (see FIG. 3) in a state in which the metal hydride stores no hydrogen. FIG. 3 shows a state in which each pellet stores hydrogen, and their volume has accordingly increased, which changes the positions of the respective ends of the multiple pellets along the layering direction to be Pa0′ and Pb0′. That is to say, changes in the position of one end (cap side) of the multiple pellets along the layering direction is represented by ΔPa=Pa0′−Pa0. Changes in the position of the other end (bottom side) of the multiple pellets along the layering direction is represented by ΔPb=Pb0′−Pb0.

Thus, changes in the overall length of the multiple pellets 24 along the layering direction are represented by ΔX=ΔPa+ΔPb. Changes in the overall length of the multiple pellets along the layering direction correspond to changes in the overall volume of the multiple pellets. As described above, by detecting the positions of both ends of the multiple pellets along the layering direction by means of the detection units 18a and 18b, such an arrangement is capable of calculating changes in the overall volume of the multiple pellets. Furthermore, by providing a detection unit to both ends of the housing unit 28 along the length direction, such an arrangement is capable of measuring the positions of both ends, which most suitably reveals changes in the volume of the layered multiple pellets. Thus, such an arrangement is capable of detecting changes in the overall volume of the multiple pellets with high precision, thereby monitoring the hydrogen storage/discharge state with high precision.

### Second Embodiment

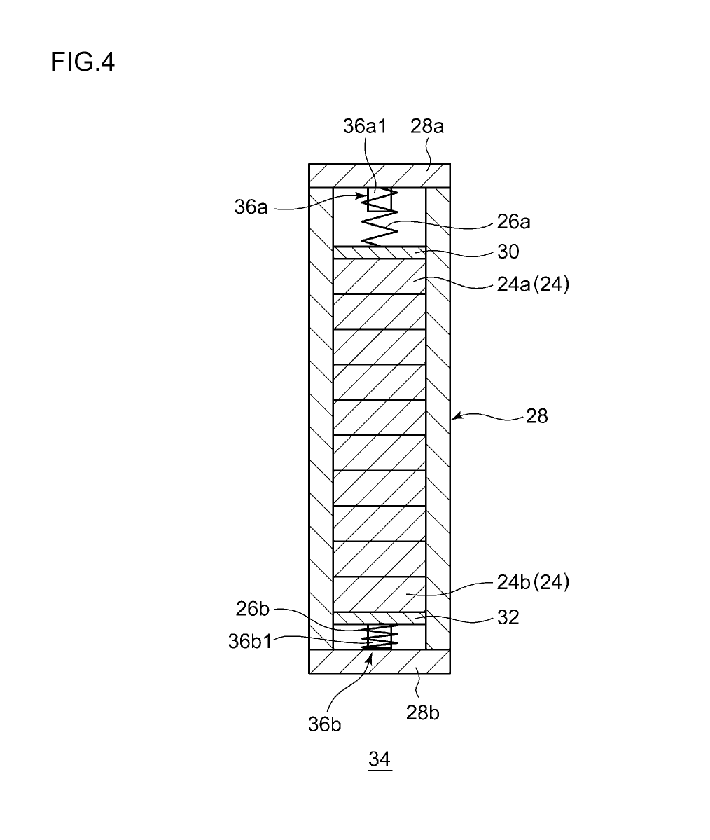

A fuel tank according to a second embodiment employs an inductance sensor as a detection unit, which is the major difference between it and the fuel tank 14 according to the first embodiment. FIG. 4 is a schematic cross-sectional view of a fuel tank according to a second embodiment. It should be noted that the same configurations and the same operations as those according to the first embodiment will be omitted as appropriate.

A fuel tank 34 includes: multiple pellets 24; springs 26a and 26b configured to support the multiple pellets 24 in a state in which they are layered such that they are mutually closest to one another while still permitting the volume of the multiple pellets 24 to change; a housing unit 28; and detection units 36a and 36b configured to detect the positions of the respective ends of the multiple pellets along the layering direction, which change due to changes in the volume of the multiple pellets 24.

The detection units 36a and 36b according to the present embodiment are each configured as an inductance sensor. The detection unit 36a is configured as a gap detection coil 36a1 fixed to the inner wall of the cap portion 28a. Furthermore, the detection unit 36b is configured as a gap detection coil 36b1 fixed to the inner wall of the bottom portion 28b. With such an inductance sensor, when changes occur in the distance between the gap detection coil 36a1 (36b1) and the support member 30 (32), the inductance of the detection coil changes. In this state, these changes in the inductance are converted into a DC voltage signal by the detection circuit. That is to say, such an arrangement is capable of calculating changes in the overall volume of the multiple pellets based upon the signal that corresponds to changes in the distance between the gap detection coil and the support member.

### Third Embodiment

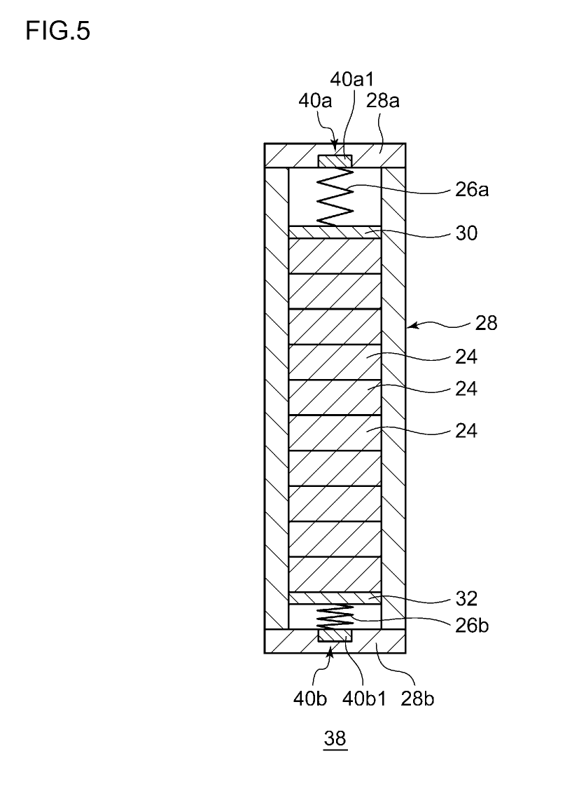

A fuel tank according to a third embodiment employs an ultrasonic level sensor as a detection unit, which is the major difference between it and the fuel tank 14 according to the first embodiment. FIG. 5 is a schematic cross-sectional view of a fuel tank according to a third embodiment. It should be noted that the same configuration and the same operation as those of the fuel tank 14 according to the first embodiment will be omitted as appropriate.

A fuel tank 38 includes: multiple pellets 24; springs 26a and 26b configured to support the pellets 24 in a state in which they are layered such that they are mutually closest to one another while still permitting the volume of the multiple pellets 24 to change; a housing unit 28; and detection units 40a and 40b configured to detect the positions of the respective ends of the multiple pellets 24 along the layering direction, which change due to changes in the volume of the multiple pellets 24.

The detection units 40a and 40b according to the present embodiment are each configured as an ultrasonic level sensor. The detection unit 40a includes a sensor unit 40a1 embedded in the inner wall of the cap portion 28a. Furthermore, the detection unit 40b includes a sensor unit 40b1 embedded in the inner wall of the bottom portion 28b. The ultrasonic level sensor is configured to convert the echo time, which is a period from a time point at which an ultrasonic wave emitted by the sensor unit 40a1 (40b1) is reflected by the support member 30 (32) up to a time point at which the ultrasonic wave thus reflected is received by the same sensor unit 40a1 (40b1), into an electric signal by means of a detection circuit. The echo time corresponds to (is proportional to) the distance between the sensor unit and the support member. Thus, by converting the echo time into the distance by calculation, such an arrangement is capable of detecting the positions of both ends of the multiple pellets along the layering direction, thereby calculating changes in the overall volume of the multiple pellets.

Description has been made regarding the detection units using three different methods. Also, an arrangement may be made employing a combination of the aforementioned methods. Description has been made in the aforementioned embodiments regarding the fuel tank including the detection units respectively arranged in the vicinity of both ends (the cap portion and bottom portion) of the fuel tank. Also, in a case in which one end of the multiple pellets is fixed to the housing unit in a state in which they are integrally supported, only a single detection unit may be provided to the other end. Such an arrangement provides a reduced number of detection units, thereby providing reduced costs.

Moreover, as the pellets are manufactured giving high priority to the hydrogen storage/discharge function, such pellets are not necessarily formed of a suitable material and in a suitable shape for the detection by the detection units. However, the fuel tanks according to the aforementioned embodiments each include the support members arranged at both ends of the layered multiple pellets. Accordingly, such an arrangement allows each support member to be formed of a suitable material (property) in a suitable shape for the detection method used by the detection units, thereby providing improved detection precision. It should be noted that such a support member is not an indispensible component, and may be omitted as appropriate.

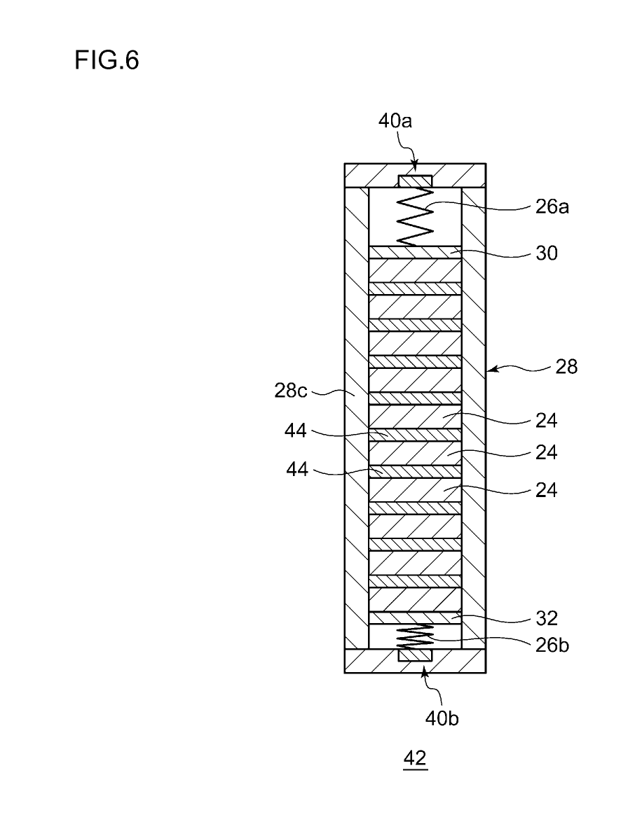

Furthermore, a plate-shaped porous member may be introduced between the adjacent pellets. FIG. 6 is a schematic cross-sectional view of a fuel tank 42 including the pellets layered such that a porous member is introduced between adjacent pellets. It should be noted that the same configurations and the same operations as those of the fuel tank 38 according to the third embodiment will be omitted as appropriate. A plate-shaped porous member 44 is held between adjacent pellets 24. Such an arrangement provides improvement in the flowability of hydrogen to/from each pellet 24 via the porous member 44, thereby facilitating the storage/discharge of hydrogen. Furthermore, after the pellets 24 store hydrogen, adjacent pellets 24, the volume of which has increased, apply force to each other. However, such force is eased by the porous members 44, thereby inhibiting cracking of the pellets 24. Furthermore, by the selection of a porous metal to be employed for such a porous member 44, such an arrangement can be designed to provide improved thermal conductivity. For example, at the top face or the bottom face of each pellet 24, the use as an intermediary of such porous members 44 made of a porous metal permits thermal conduction between adjacent pellets 24, or between each pellet 24 and the body portion 28c of the housing unit 28. Such a porous metal is preferably formed of a metal having high thermal conductivity such as copper, aluminum, or the like, for example.

It should be noted that each pellet 24 may be adhered to an adjacent porous member 44. Such an arrangement is capable of supporting the layered state of the multiple pellets while permitting the volume of the multiple pellets to change, even if one of the springs 26a or 26b is omitted.

### [Changes in Attitude of Fuel Tank]

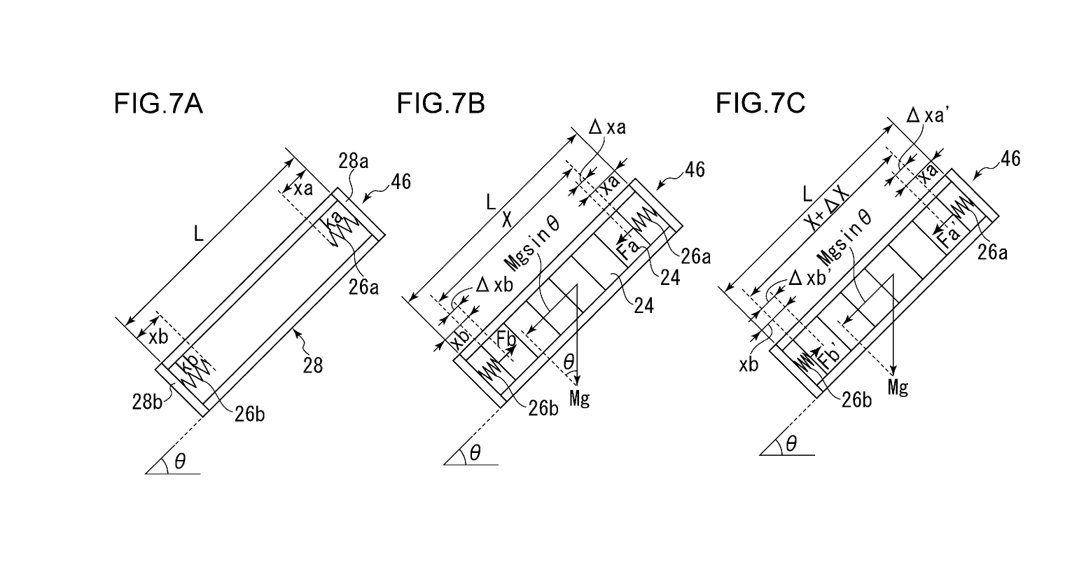

Next, description will be made regarding the relation between changes in the attitude of the fuel tank and the hydrogen storage state. FIG. 7A is a schematic diagram showing the fuel tank in an inclined condition, in a state in which the housing unit houses no pellets. FIG. 7B is a schematic diagram showing the fuel tank in an inclined condition, in a state in which the housing unit houses multiple pellets storing no hydrogen. FIG. 7C is a schematic diagram showing the fuel tank in an inclined condition, in a state in which the housing unit houses multiple pellets storing hydrogen. It should be noted that the detection units and the support members are not shown in the drawings. Furthermore, the angle of inclination of the fuel tank is represented by θ, with the horizontal level as 0°.

With the fuel tank 46 shown in FIG. 7A, the spring 26a is configured such that, in a state in which no load is applied to the spring 26a, it has a length xa and a spring constant ka. In addition, the spring 26b is configured such that, in a state in which no load is applied to the spring 26b, it has a length xb and a spring constant kb. Furthermore, description will be made with the distance between the cap portion 28a and the bottom portion 28b of the housing unit 28 as L.

Next, as shown in FIG. 7B, multiple pellets are housed in the fuel tank 46. In this stage, the pellets store essentially no hydrogen. The multiple pellets 24 are held by means of the compressed springs 26a and 26b, thereby holding the multiple pellets 24 such that there are no gaps between them. With the overall length of the multiple pellets 24 along the layering direction as X, with the overall mass of the multiple pellets 24 as M, with the compression displacement of the spring 26a as Δxa, with the compression displacement of the spring 26b as Δxb, with the force applied from the spring 26a to the multiple pellets 24 as Fa, and with the force applied from the spring 26b to the multiple pellets 24 as Fb, the following Expressions (1) through (4) are introduced.

L=(xa−Δxa)+X+(xb−Δxb) (1)

Fb=Mg sin θ+Fa (2)

Fa=Δxa×ka (3)

Fb=Δxb×kb (4)

Next, as shown in FIG. 7C, the fuel tank 46 shown in FIG. 7B is charged with hydrogen such that the multiple pellets each store hydrogen. After the pellets store hydrogen, the volume of each pellet increases, which further compresses the springs 26a and 26b. With the amount of expansion of the multiple pellets 24 along the layering direction as ΔX, with the compression displacement of the spring 26a as Δxa′, with the compression displacement of the spring 26b as Δxb′, with the force applied from the spring 26a to the multiple pellets 24 as Fa′, and with the force applied from the spring 26b to the multiple pellets 24 as Fb', the following Expressions (5) through (8) are introduced.

L=(xa−Δxa′)+(X+ΔX)+(xb−Δxb′) (5)

Fb′=Mg sin θ+Fa′ (6)

Fa′=Δxa′×ka (7)

Fb′=Δxb′×kb (8)

From the aforementioned Expressions (1) through (8), the following relational expressions (9) through (11) are introduced.

ΔX=(xa−Δxa′)+(Δxb′−Δxb) (9)

ΔX=((ka+kb)/kb)×(Δxa′−Δxa) (10)

ΔX=((ka+kb)/ka)×(Δxb′−Δxb) (11)

As can be clearly understood from Expression (9), by detecting the displacement of both ends of the multiple pellets by means of two detection units, such an arrangement is capable of calculating the amount of expansion ΔX of the multiple pellets along the layering direction, thereby calculating changes in the volume of the multiple pellets. As a result, such an arrangement is capable of calculating the remaining level of hydrogen stored in the fuel tank. Furthermore, as can be understood from Expressions (10) and (11), the amount of expansion ΔX of the multiple pellets along the layering direction does not depend on the angle of inclination θ of the fuel tank 46. Specifically, when the fuel tank 46 is charged with hydrogen starting from a state in which the fuel tank has not been charged with hydrogen, the amount of expansion ΔX is unambiguously determined by the amount of displacement of both ends of the layered multiple pellets, i.e., (Δxa′−Δxa) and (Δxb′−Δxb). Thus, there is no need to estimate the relation between the amounts of displacement (Δxa′−Δxa) and (Δxb′−Δxb) and the amount of expansion ΔX, thereby facilitating the calculation processing.

Furthermore, as can be understood from the aforementioned Expressions (10) and (11), by providing the information with respect to the spring constants ka and kb of the respective springs 26a and 26b, such an arrangement requires only a single detection unit to calculate the amount of expansion ΔX.

### Fourth Embodiment

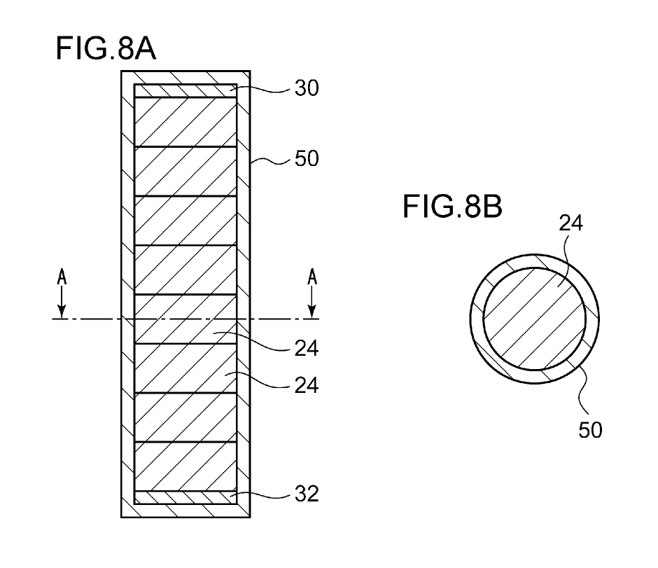

Next, description will be made regarding a fuel tank employing a support mechanism using a method that differs from the support mechanism 26 described in the first embodiment through the third embodiment. FIG. 8A is a schematic cross-sectional view showing a support mechanism according to a fourth embodiment. FIG. 8B is a cross-sectional view of FIG. 8A taken along the line A-A.

The support mechanism according to the present embodiment is configured as a net-shaped elastic member 50, and is configured such that it monolithically surrounds the multiple layered pellets 24 and the support members 30 and 32 arranged at both ends thereof. That is to say, by means of the elastic member 50, such an arrangement is capable of maintaining the layered state of the multiple pellets 24 while still permitting the volume of the multiple pellets 24 to change. It should be noted that the support members 30 and 32 may be omitted. The elastic member 50 is formed of a material having high thermal conductivity, such as copper, phosphor bronze, stainless steel wire, or the like, in the form of a net, which thereby provides elasticity.

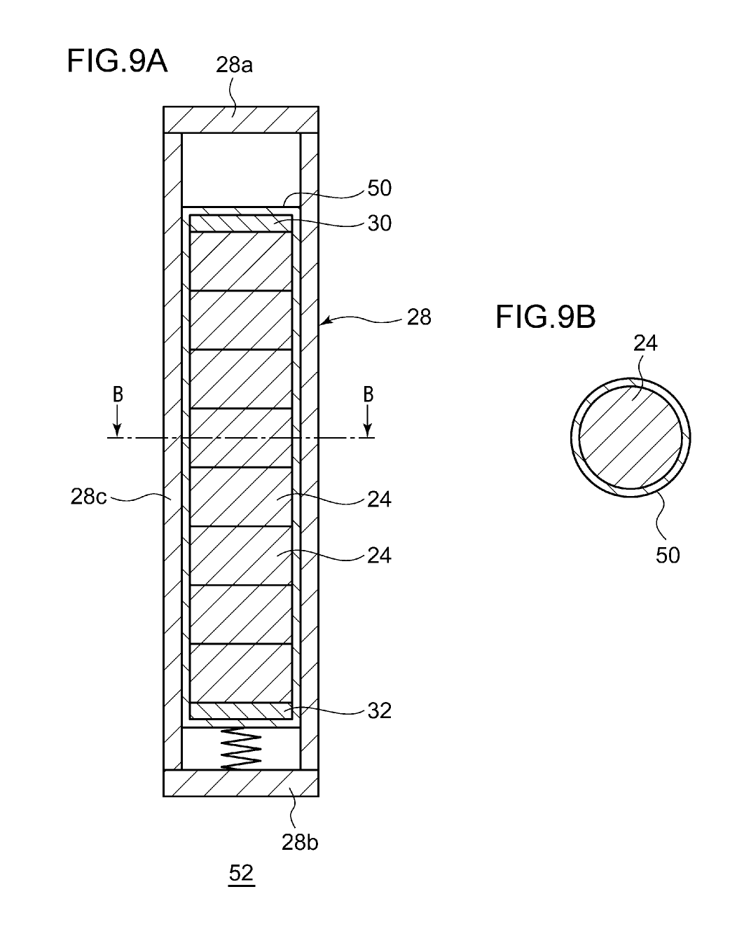

FIG. 9A is a schematic cross-sectional view of the fuel tank according to the fourth embodiment. FIG. 9B is a cross-sectional view of FIG. 9A taken along line B-B. The fuel tank 52 shown in FIG. 9A includes: multiple pellets 24 formed of a metal hydride; a net-shaped elastic member 50 configured to support the multiple pellets 24 in a state in which they are layered such that they are mutually closest to one another while still permitting the volume of the multiple pellets 24 to change; a housing unit 28 configured to house the multiple pellets 24; and a detection unit (not shown) configured to detect the positions of both ends of the multiple pellets along the layering direction, which change due to changes in the volume of the multiple pellets 24.

The multiple pellets 24 shown in FIG. 9A each store hydrogen. Accordingly, the volume of the multiple pellets 24 is greater than that of the multiple pellets 24 shown in FIG. 8A. Accordingly, each pellet 24 expands not only along the length direction of the body portion 28c, but also expands along the radial direction of the body portion 28c. As each pellet 24 expands along the length direction of the body portion 28c, the elastic member 50 according to the present embodiment lengthens in the vertical direction. Accordingly, the thickness of the elastic member 50 positioned between the pellets 24 and the inner wall of the body portion 28c becomes thinner (see FIGS. 9A and 9B). After the thickness of the elastic member 50 becomes thinner as described above, such an arrangement allows room for the pellets 24 to expand along the radial direction of the body portion 28c. Thus, such an arrangement reduces stress that occurs between the pellets 24 and the body portion 28c when the pellets 24 expand, thereby inhibiting cracking and deformation of the pellets 24. Furthermore, the elastic member 50 is formed in the shape of a net. Thus, such an arrangement provides improvement in the flowability of hydrogen stored in the housing unit 28.

### Fifth Embodiment

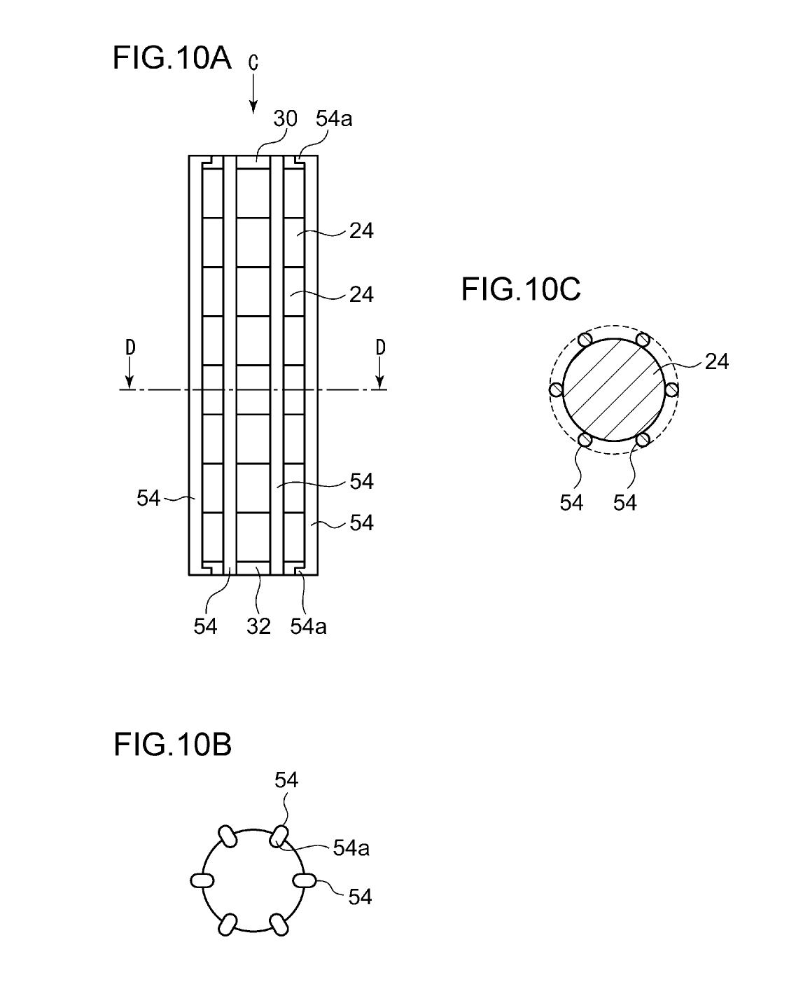

FIG. 10A is a schematic side view showing a support mechanism according to a fifth embodiment. FIG. 10B is a top view showing the support mechanism shown in FIG. 10A as viewed from the direction C. FIG. 10C is a cross-sectional view of FIG. 10A taken along the line D-D.

The support mechanism according to the present embodiment is configured as a set of multiple springs 54. Each spring 54 is a rod-shaped member, both ends of which are each formed in the shape of a hook. Each spring 54 holds and links by hook members 54a, both ends of the layered multiple pellets 24, or the support members 30 and 32 respectively arranged on the outer side of the respective ends of the multiple pellets 24, while applying force to the multiple pellets such that they become closer to one another along the layering direction. That is to say, by means of the springs 54, such an arrangement is capable of maintaining the layered state of the multiple pellets 24 while still permitting the volume of the multiple pellets 24 to change. It should be noted that the support members 30 and 32 may be omitted. The springs 54 are formed of a material having high thermal conductivity such as copper, phosphor bronze, stainless steel wire, or the like, which thereby provides elasticity.

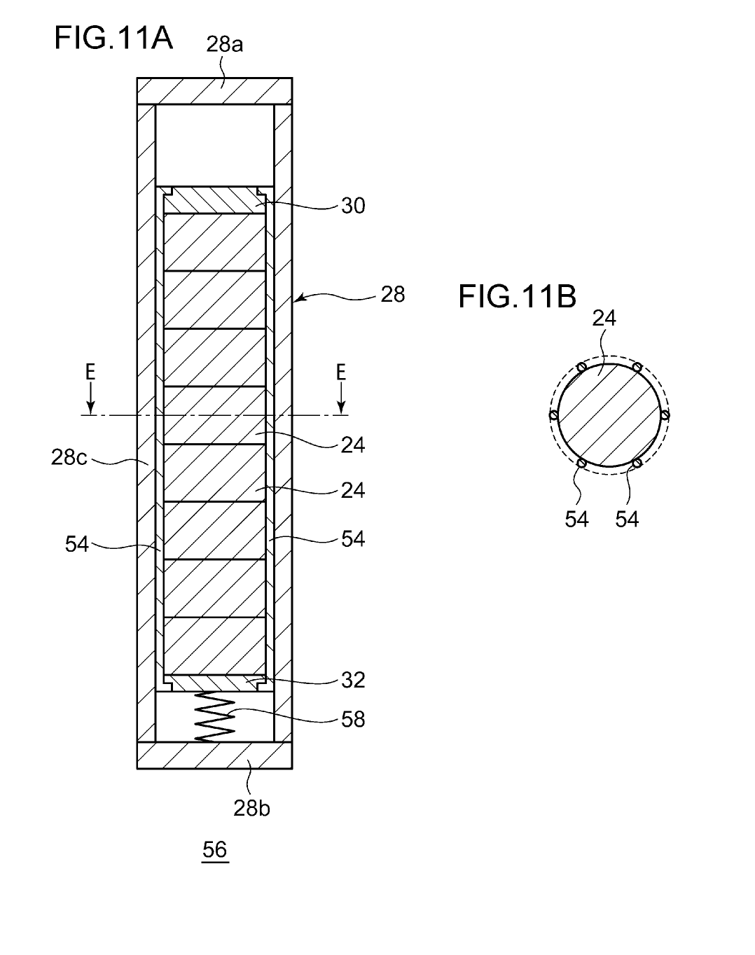

FIG. 11A is a schematic cross-sectional view of a fuel tank according to a fifth embodiment, and FIG. 11B is a cross-sectional view of FIG. 11A taken along the line E-E. A fuel tank 56 shown in FIG. 11A includes: multiple pellets 24 formed of a metal hydride; springs 54 configured to support the pellets 24 in a layered state such that they are mutually closest to one another while still permitting the volume of the multiple pellets 24 to change; a housing unit 28 configured to house the multiple pellets 24; a detection unit (not shown) configured to detect the positions of both ends of the multiple pellets along the layering direction which change due to changes in the volume of the multiple pellets 24; and a spring 58 configured to link the support member 32 and the bottom portion 28b. The spring 58 restricts free movement of the multiple pellets monolithically layered in the housing unit 28.

The multiple pellets 24 shown in FIG. 11A each store hydrogen. Accordingly, the volume of the multiple pellets 24 is greater than that of the multiple pellets 24 shown in FIG. 10A. Accordingly, each pellet 24 expands not only along the length direction of the body portion 28c, but also expands along the radial direction of the body portion 28c. With the springs 54 according to the present embodiment, as the pellets 24 expand along the length direction of the body portion 28c, each spring 54 also expands along the vertical direction. Accordingly, the diameter of each spring 54 positioned between the pellets 24 and the inner wall of the body portion 28c becomes smaller (see FIG. 11A and FIG. 11B). After the diameter of each spring 54 becomes smaller as described above, such an arrangement allows room for the pellets 24 to expand along the radial direction of the body portion 28c. Thus, such an arrangement reduces stress that occurs between the pellets 24 and the body portion 28c when the pellets 24 expand, thereby inhibiting cracking and deformation of the pellets 24. Furthermore, six springs 54 are disposed at regular intervals along the outer face of the disk-shaped pellets 24, thereby providing improvement in the flowability of hydrogen stored in the housing unit 28. It should be noted that a single coiled spring configured to surround the outer face of the multiple pellets in a spiral manner may be employed instead of employing the multiple springs 54.

### Sixth Embodiment

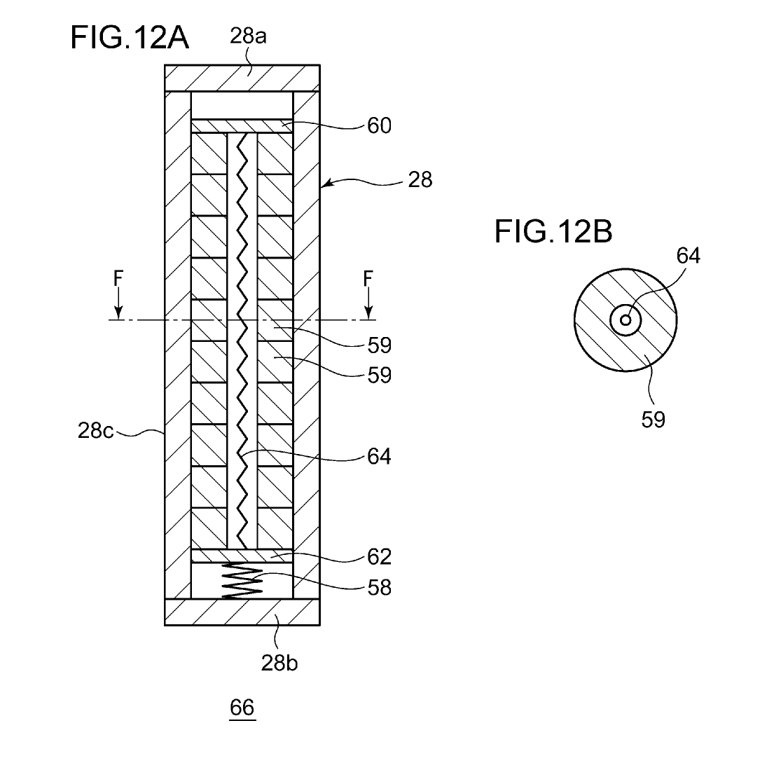

FIG. 12A is a schematic side view showing a support mechanism according to a sixth embodiment, and FIG. 12B is a cross-sectional view of FIG. 12A taken along the line F-F.

The support mechanism according to the present embodiment includes: a pair of support members 60 and 62 configured to support, from the outside, both ends of the multiple cylindrical pellets 59 along the layering direction; and a tension spring 64 configured to link the pair of support members 60 and 62, and to pull the pair of support members 60 and 62 such that they approach each other. The tension spring 64 is arranged such that it passes through the central portion of each of the cylindrical pellets 59. By means of such a tension spring 64, such an arrangement is capable of maintaining the layered state of the multiple pellets 59 while still permitting the volume of the multiple pellets 59 to change.

Furthermore, a fuel tank 66 according to the present embodiment includes: multiple cylindrical pellets 59 formed of a metal hydride; a support mechanism configured to support the multiple pellets 59 in the layered state such that they are mutually closest to one another; a housing unit 28 configured to house the multiple pellets 59; a detection unit (not shown) configured to detect the positions of both ends of the multiple pellets along the layering direction, which change due to changes in the volume of the multiple pellets 59; and a spring 58 configured to link the support member 62 and the bottom portion 28b. The spring 58 restricts free movement of the multiple pellets monolithically layered in the housing unit 28.

### Seventh Embodiment

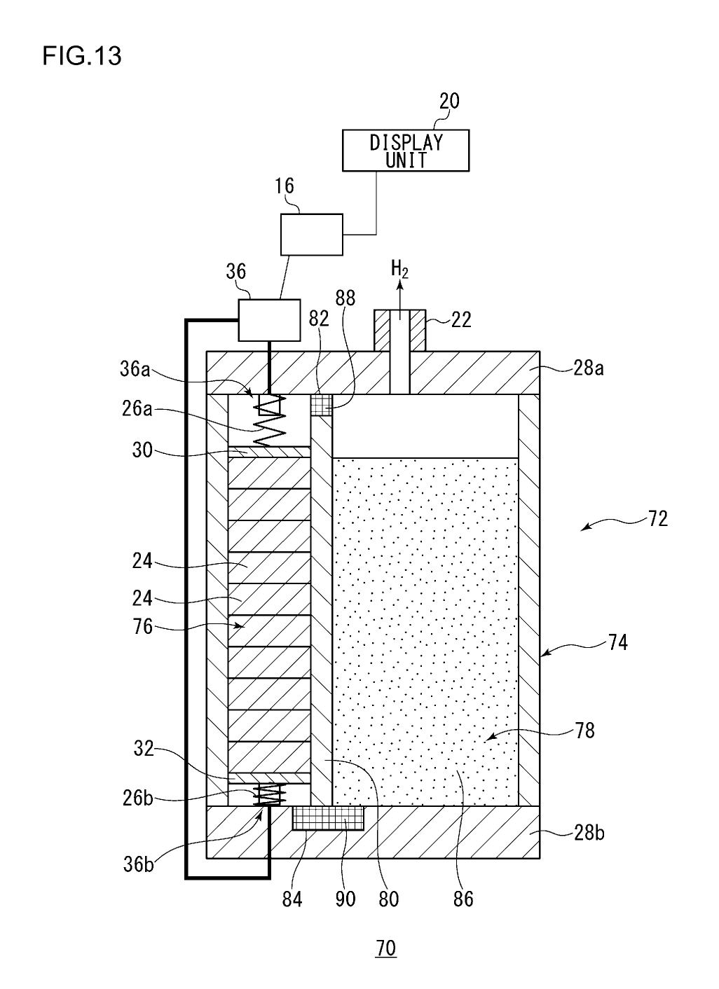

A hydrogen remaining level detection system according to the present embodiment has a configuration in which multiple cylindrical fuel chambers are formed within a housing unit of a fuel tank. With such an arrangement, a detection unit is provided to at least one of the fuel chambers. FIG. 13 is a diagram showing a schematic configuration of a hydrogen remaining level detection system 70 according to a seventh embodiment.

The hydrogen remaining level detection system 70 includes a fuel tank 72, a calculation unit 16, and a display unit 20. The fuel tank 72 includes a housing unit 74 in which multiple cylindrical fuel chambers are formed. Each fuel chamber 76 has approximately the same configuration as that of the fuel tank 34 shown in FIG. 4. Accordingly, the same components are denoted by the same reference symbols, and description thereof will be omitted.

A fuel chamber 78 is separated from the adjacent fuel chamber 76 by a partition 80. The fuel chamber 78 houses metal hydride powder or pellets formed of a metal hydride. Communicating passages 82 and 84 are respectively formed between the cap portion 28a and the partition 80 and between the bottom portion 28b and the partition 80, such that the fuel chambers 76 and 78 communicate with each other. Furthermore, filters 88 and 90 are provided to the communicating passages 82 and 84, respectively, so as to prevent the metal hydride powder 86 housed in the fuel chamber 78 from entering the fuel chamber 76. The filters 88 and 90 are each configured so as to allow at least hydrogen to flow through the communicating passages.

With the fuel tank 72 configured as described above, the fuel chamber 76, which is one of multiple fuel chambers, includes multiple pellets 24, springs 26a and 26b, and a detection unit 36 (36a and 36b). By estimating changes in the volume of the multiple pellets 24 housed in the fuel chamber 76, such an arrangement is capable of estimating changes in the overall volume of the metal hydride housed in the fuel tank. The calculation unit 16 calculates the remaining level of hydrogen stored in the housing unit 74 based upon a signal output from the detection unit 36 of the fuel tank 72.

### Eighth Embodiment

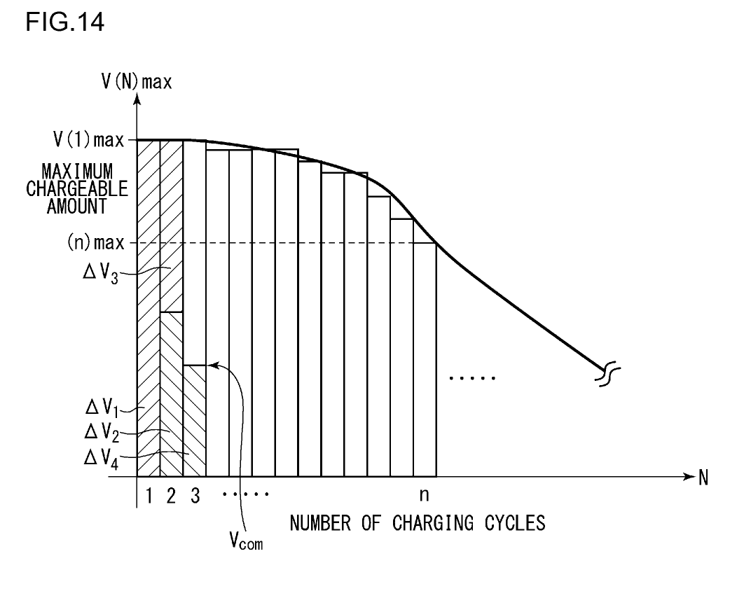

With typical metal hydrides, with repeated storage and discharge of hydrogen, the maximum amount of hydrogen with which the alloy can be charged tends to gradually decrease. FIG. 14 is a graph showing the relation between the number of hydrogen charging cycles and the maximum chargeable amount.

As the amount of stored hydrogen becomes greater, the volume of such a metal hydride increases. Accordingly, there is a correspondence (proportional relation) between the amount of stored hydrogen and changes in both ends (expansion length ΔX) of the multiple pellets each formed of a metal hydride. Thus, as can be understood from the aforementioned Expressions (9) through (11), by detecting changes in both ends of the pellets by means of the detection unit, such an arrangement is capable of calculating the expansion length ΔX, thereby calculating the amount of stored hydrogen. On the other hand, as shown in FIG. 14, the maximum chargeable amount V(N)max is represented by a function of the number of charging cycles, i.e., N. As the number of charging cycles becomes greater, the maximum chargeable amount gradually decreases. Accordingly, when the maximum chargeable amount N(N)max changes, the percentage of hydrogen remaining changes even if the fuel tank is charged with the same amount of hydrogen.

Description will be made in the present embodiment regarding a configuration which allows the hydrogen remaining level to be calculated with higher precision even after repeatedly charging and discharging with hydrogen, in a hydrogen remaining level detection system configured to charge a fuel tank with hydrogen by means of a hydrogen charging apparatus and a fuel cell system configured to drive fuel cells using the fuel tank thus charged with hydrogen. It should be noted that the function of the maximum chargeable amount V(N)max can change depending on the kind of metal hydride, the grain diameter, the charging pressure, the composition of mixed materials, etc. Accordingly, the maximum chargeable amount V(N)max function should be calculated by experiment or simulation.

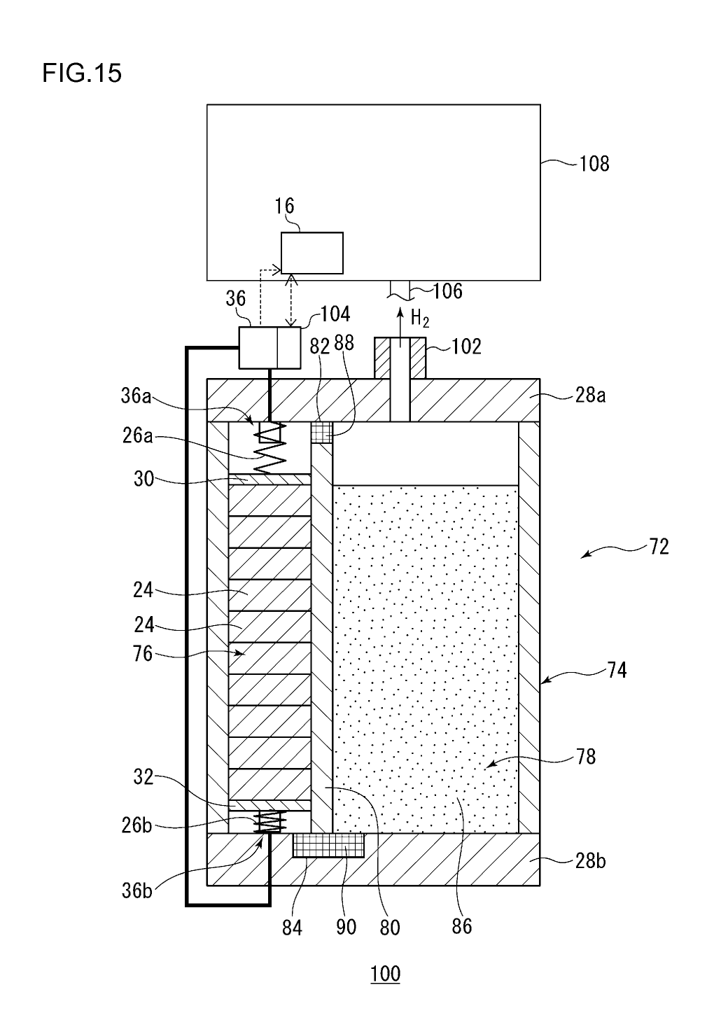

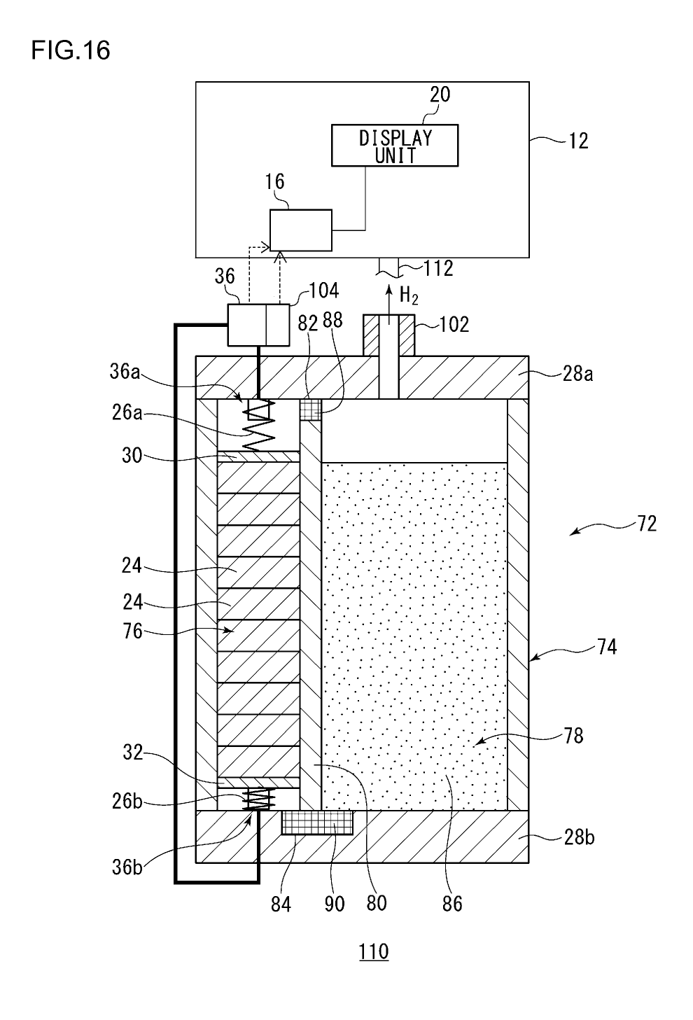

FIG. 15 is a diagram which shows a schematic configuration of a hydrogen remaining detection system according to an eighth embodiment. FIG. 16 is a diagram which shows a schematic configuration of a fuel cell system according to the eighth embodiment.

A hydrogen remaining level detection system 100 shown in FIG. 15 includes: a charging/discharging opening 102 configured to allow the fuel tank 72 to be charged with hydrogen from outside the tank, and to allow hydrogen to be discharged from the fuel tank 72 to outside the tank; and a storage unit 104 configured to store information with respect to the cumulative amount of charged hydrogen, which is the major difference between it and the hydrogen remaining level detection system 70 according to the seventh embodiment. Furthermore, the hydrogen remaining level detection system 100 further includes a hydrogen charging apparatus 108 configured to charge the fuel tank 72 with hydrogen. The hydrogen charging apparatus 108 includes a connection portion 106 detachably connected to the charging/discharging opening 102 formed in the fuel tank 72. Furthermore, the calculation unit 16 is disposed in the hydrogen charging apparatus 108.

It should be noted that, in the hydrogen remaining level detection system 100 shown in FIG. 15, the same components as those in the hydrogen remaining level detection system 70 according to the seventh embodiment are denoted by the same reference symbols, and description thereof will be omitted.

Next, description will be made regarding the operation of the hydrogen remaining level detection system 100 when the fuel tank 72 is charged with hydrogen using the hydrogen charging apparatus 108.

First, the charging/discharging opening 102 of the fuel tank 72 is connected to the connection portion 106 of the hydrogen charging apparatus 108. In this stage, a state is established in which communication is possible between the calculation unit 16 and the detection unit 36 and between the calculation unit 16 and the storage unit 104. Such communication may be made by a wireless method or a wired method.

After the fuel tank 72 and the hydrogen charging apparatus 108 are connected to each other, the calculation unit 16 reads out, from the storage unit 104 of the fuel tank 72, the cumulative hydrogen charging amount Vcum and the function V(N)max that represents the maximum chargeable amount as shown in FIG. 14. In the case of a new, unused fuel tank 72, the cumulative charging amount Vcum is defined to be zero.

When charging with hydrogen is started, the calculation unit 16 calculates the expansion length ΔX of the multiple pellets 24 based upon the positions of both ends of the multiple pellets 24 along the layering direction detected by the detection unit 36. After charging with hydrogen ends, the calculation unit 16 calculates the amount of charged hydrogen ΔV based upon the expansion length ΔX in this stage. Subsequently, the calculation unit 16 calculates the sum of the amount of charged hydrogen ΔV₁ thus calculated and the cumulative amount of charged hydrogen Vcum, and instructs the storage unit 104 to store the calculation result as an updated cumulative amount of charged hydrogen (Vcum=Vcum+ΔV₁). Such an arrangement allows the cumulative amount of charged hydrogen Vcum to be updated for each fuel tank 72. Also, a flow meter may be provided to the hydrogen charging apparatus 108. Based upon the amount of charged hydrogen ΔVf measured by the flow meter, such an arrangement is capable of calculating the amount of charged hydrogen ΔV₁ with higher precision.

Next, description will be made regarding a method for calculating the maximum chargeable amount V(N)max for the fuel tank 72 in this cycle based upon the cumulative charging amount Vcum.

Furthermore, description will be made below regarding the reason why the data of the cumulative amount of charged hydrogen Vcum is stored in the storage unit 104. If the hydrogen charging cycle is repeated such that each hydrogen charging cycle is started in a state in which the hydrogen tank stores no hydrogen, and charging is performed to such a maximum chargeable amount of hydrogen, the maximum chargeable amount V(N)max can be calculated in a simple manner by counting the number of hydrogen charging cycles. However, in some cases, charging with hydrogen is started in a state in which the hydrogen has not been completely exhausted. Also, in some cases, charging is not performed to such a maximum chargeable amount of hydrogen. In such a case, only counting the hydrogen charging cycles in such a manner does not provide the maximum chargeable amount V(N)max with sufficient precision.

That is to say, as shown in FIG. 14, with the charging amount in the first cycle as ΔV₁, with the charging amount in the second cycle as ΔV₂, with the charging amount in the third cycle as ΔV₃, and with the charging amount in the fourth cycle as ΔV₄, the cumulative charging amount Vcum is represented by the position denoted by the arrow in the drawing. Accordingly, the cumulative charging amount Vcum corresponds to a number of charging cycles N=3, and the maximum chargeable amount with respect to the fuel tank in this stage is represented by V(3)max. It should be noted that the calculation unit 16 may instruct the storage unit 104 to store the maximum chargeable amount V(3)max in this stage.

As described above, the calculation unit 16 is capable of calculating the remaining level of hydrogen stored in the housing unit 74 based upon the cumulative charging amount Vcum stored in the storage unit 104 and the positions of both ends of the multiple pellets along the layering direction detected by the detection unit 36. Thus, such an arrangement is capable of calculating the remaining level of hydrogen stored in the fuel tank 72 with higher precision even after the metal hydride is repeatedly subjected to hydrogen charging and discharging.

Furthermore, although the maximum hydrogen chargeable amount of the metal hydride tends to become smaller after repeatedly performing storage and discharge of hydrogen, the hydrogen remaining level detection system 100 instructs the storage unit 104 to store the information with respect to the cumulative amount of charged hydrogen Vcum, thereby enabling correction of the calculation of the hydrogen remaining level.

Also, when charging with hydrogen so as to reach the fully charged state is started from a state in which the hydrogen has been exhausted, the amount ΔVf of charged hydrogen measured by a flow meter in the hydrogen charging step, or the amount of charged hydrogen ΔV calculated based upon the expansion length ΔX calculated based upon the positions of both ends of the multiple pellets along the layering direction detected by the detection unit 36, may be compared with the maximum chargeable amount V(N)max. A state in which there is a large difference between the amount of charged hydrogen ΔVf or ΔV and the maximum chargeable amount V(N)max can be considered to indicate a disagreement with respect to the rate of progression in the decrease in the maximum chargeable amount V(N)max which depends on the cumulative charging amount Vcum.

Accordingly, as a correction judgment mode, hydrogen charging may be repeatedly executed several times, each time starting from a state in which the hydrogen has been exhausted to the full charged state, and the amount of charged hydrogen ΔVf measured by a flow meter as described above, or the amount of charged hydrogen ΔV calculated based upon the expansion length ΔX, may be compared with the maximum chargeable amount V(N)max. With such an arrangement, in a case in which either the difference between the hydrogen charged amount ΔVf and the maximum chargeable amount V(N)max, or the difference between the charged amount ΔV and the maximum chargeable amount V(N)max, is greater than a predetermined value (e.g., in a case in which the difference is equal to or greater than 5% of the maximum chargeable amount V(N)max), the maximum chargeable amount V(N)max may be corrected and updated to a maximum chargeable amount V(N′)max (N≠N′) that corresponds to the hydrogen charged amount ΔVf or the charged amount ΔV. Also, if there is a large difference between the amount of charged hydrogen ΔV calculated based upon the expansion length ΔX and the amount of charged hydrogen ΔVf measured by the flow meter in the hydrogen charging step, judgment may be made that deterioration or the like has occurred in the pellets to be detected by the detection unit, and that measurement of the remaining level is not possible. In this case, an alarm may be displayed.

Also, the hydrogen charging apparatus 108 may further include a display unit configured to display the information with respect to the remaining level of hydrogen stored in the housing unit 74 calculated by the calculation unit 16. Such an arrangement allows the hydrogen remaining level to be monitored in a simple manner.

The calculation unit 16 is provided to the hydrogen charging apparatus 108. Such an arrangement is capable of calculating the hydrogen remaining level without providing such a calculation unit for each fuel tank, thereby contributing to a reduction in the cost of the fuel tank.

Next, description will be made regarding a fuel cell system according to the present embodiment. A fuel cell system 110 shown in FIG. 16 has a configuration obtained by eliminating the hydrogen charging apparatus 108 from the hydrogen remaining level detection system 100 shown in FIG. 15, and by mounting the fuel cell unit 12 on the fuel tank 72. The fuel cell unit 12 includes a connection portion 112 detachably connected to the charging/discharging opening 102 formed in the fuel tank 72. Furthermore, the calculation unit 16 and the display unit 20 are disposed in the fuel cell unit 12.

It should be noted that, in the fuel cell system 110 shown in FIG. 16, the same components as those in the hydrogen remaining level detection system 100 shown in FIG. 15 are denoted by the same reference symbols, and description thereof will be omitted.

Next, description will be made regarding the operation of the fuel cell system 110 in a step in which the fuel cell unit 12 generates electric power using hydrogen discharged from the fuel tank 72.

First, the charging/discharging opening 102 of the fuel tank 72 is connected to the connection portion 112 of the fuel cell system 110. In this stage, a state is established in which communication is possible between the calculation unit 16 and the detection unit 36 and between the calculation unit 16 and the storage unit 104. Such communication may be made by a wireless method or a wired method.

After the fuel tank 72 and the fuel cell unit 12 are connected to each other, the calculation unit 16 reads out, from the storage unit 104 of the fuel tank 72, the cumulative hydrogen charging amount Vcum and the maximum chargeable amount V(N)max function as shown in FIG. 14.

When hydrogen discharge to the fuel cell unit 12 is started, the calculation unit 16 calculates the expansion length ΔX of the multiple pellets 24 based upon the positions of both ends of the multiple pellets 24 along the layering direction detected by the detection unit 36. After hydrogen discharge ends (electric power generation ends), the calculation unit 16 calculates the amount of remaining charged hydrogen ΔV based upon the expansion length ΔX in this stage. Subsequently, the calculation unit 16 calculates the remaining level based upon the amount of charged hydrogen ΔV thus calculated, the cumulative amount of charged hydrogen Vcum read out from the storage unit 104, and the maximum chargeable amount V(N)max. The remaining level (%) is calculated using the following expression.

The remaining level(%)=the amount of charged hydrogen ΔV/maximum chargeable amount V(N)max×100.

The remaining level thus calculated is displayed on the display unit 20. It should be noted that the calculation unit 16 may calculate the remaining percentage relative to the initial capacity by displaying the remaining level (%) with the initial maximum chargeable amount V(1)max of the fuel tank 72 as a base.

As described above, with the fuel cell system 110, the calculation unit 16 is capable of calculating the remaining level of hydrogen stored in the housing unit 74 based upon the cumulative charging amount Vcum stored in the storage unit 104 and the positions of both ends of the multiple pellets along the layering direction detected by the detection unit 36. Thus, such an arrangement is capable of calculating the remaining level of hydrogen stored in the fuel tank 72 with higher precision even after the metal hydride is repeatedly subjected to hydrogen storage and discharging.

Furthermore, the fuel cell unit 12 includes the display unit 20 configured to display the information with respect to the remaining level of hydrogen stored in the housing unit 74 calculated by the calculation unit 16. Thus, such an arrangement allows the hydrogen remaining level to be monitored in a simple manner.

Furthermore, the calculation unit 16 is provided to the fuel cell unit 12. Thus, such an arrangement is capable of calculating the hydrogen remaining level without providing such a calculation unit for each fuel tank, thereby contributing to a reduction in the cost of the fuel tank.

### MODIFICATION

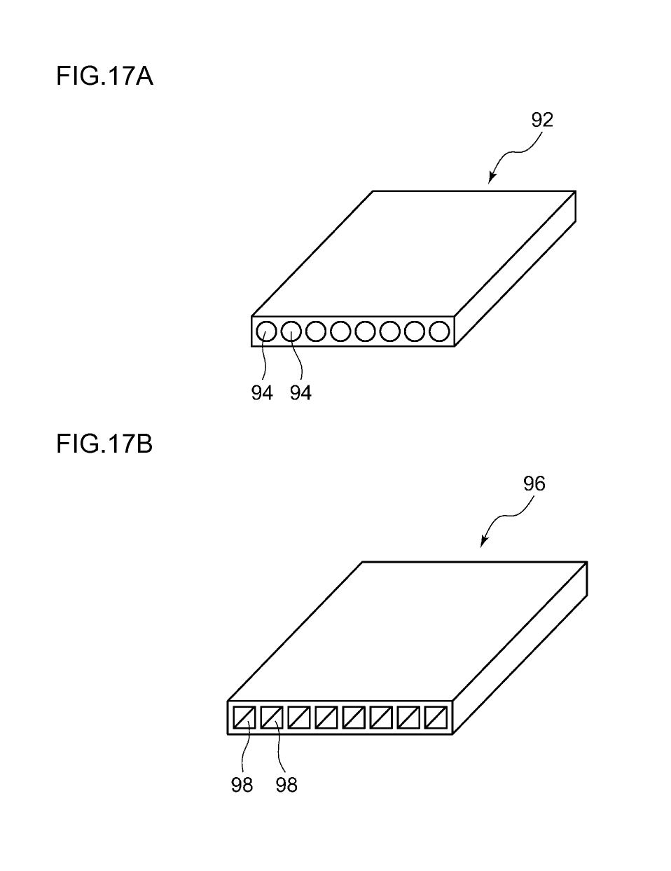

Next, description will be made regarding a modification of a cylindrical portion included in the housing unit. FIGS. 17A and 17B are perspective views each showing a modification of the housing unit. A housing unit 92 shown in FIG. 17A has a structure in which fuel chambers 94 each formed as a cylindrical space are severally arranged in the form of a line. On the other hand, the housing unit 96 shown in FIG. 17B has a structure in which fuel chambers 98 each formed as a quadrangular space are severally arranged in the form of a line. With such a housing unit 92 (96) having such multiple fuel chambers, by providing the aforementioned multiple pellets, a support mechanism, and a detection unit, to a single fuel chamber 94 (98), such an arrangement is capable of estimating changes in the overall volume of the metal hydride stored in the fuel tank.

As described above, the hydrogen remaining level detection systems and the fuel cell systems according to the aforementioned embodiments are each capable of detecting changes in the volume of the metal hydride due to the storage and discharge of hydrogen regardless of the attitude of the fuel tank, thereby estimating the remaining level of hydrogen stored in the fuel tank based upon the detection result.

Description has been made regarding the present invention with reference to the aforementioned embodiments. However, the present invention is not restricted to the aforementioned embodiments. Also, various kinds of combinations or substitutions of the components according to the aforementioned embodiments may be made, which are also encompassed within the scope of the present invention. Also, various modification such as design changes may be made for the fuel cells or the fuel cell systems according to the aforementioned embodiments based upon the knowledge of those skilled in this art, which are also encompassed within the scope of the present invention.

What is claimed is:

1. A fuel tank comprising:
a plurality of pellets formed of a hydrogen storage metal which is capable of storing hydrogen to be supplied to fuel cells;
a support mechanism configured to support the plurality of pellets such that they are layered mutually closest to one another while still permitting the volume of the plurality of pellets to change;
a housing unit configured to house the plurality of pellets supported by the supporting mechanism such that they are layered; and
a detection unit configured to detect the positions of both ends of the plurality of pellets along the layering direction, which changes due to changes in the volume of the plurality of pellets.

2. A fuel tank according to claim 1, wherein the support mechanism is configured as elastic members respectively arranged between one end of the plurality of pellets and the inner wall of the housing unit and between the other end of the plurality of pellets and the inner wall of the housing unit,
and wherein the elastic members are configured to apply force to both ends of the plurality of pellets.

3. A fuel tank according to claim 1, wherein the support mechanism is configured as an elastic member configured to connect both ends of the plurality of pellets along the layering direction, and to hold both ends of the plurality of pellets by applying force to both ends thereof along the layering direction.

4. A fuel tank according to claim 1, wherein the support mechanism comprises:
a pair of support members configured to externally support both ends of the plurality of pellets along the layering direction; and
an elastic member configured to connect the pair of support members, and to hold the pair of support members by applying force along the layering direction.

5. A fuel tank according to claim 1, further comprising a porous member introduced between adjacent pellets.

6. A fuel tank according to claim 5, wherein the porous member is adhered to the pellets.

7. A fuel tank according to claim 5, wherein the porous member is formed of a porous metal.

8. A fuel tank according to claim 1, wherein the housing unit comprises a plurality of respectively communicating cylindrical portions,
and wherein the plurality of cylindrical portions each house at least a hydrogen storage metal,
and wherein at least one of the plurality of cylindrical portions includes the plurality of pellets, the support mechanism, and the detection unit.

9. A hydrogen remaining level detection system comprising:
a fuel tank according to claim 1; and
a calculation unit configured to calculate the remaining level of hydrogen stored in the housing unit based upon a signal output from the detection unit.

10. A hydrogen remaining level detection system according to claim 9, wherein the fuel tank further comprises:
a charging/discharging opening configured to allow charging with hydrogen from the outside, and discharging of hydrogen to the outside; and
a storage unit configured to store information with respect to a cumulative amount of charged hydrogen.

11. A hydrogen remaining level detection system according to claim 10, wherein the calculation unit is configured to calculate the remaining level of hydrogen stored in the housing unit based upon the information with respect to the cumulative charging amount stored in the storage unit and the positions of both ends of the plurality of pellets along the layering direction detected by the detection unit.

12. A hydrogen remaining level detection system according to claim 10, further comprising a display unit configured to display the information with respect to the remaining level of hydrogen stored in the housing unit calculated by the calculation unit.

13. A hydrogen remaining level detection system according to claim 10, further comprising a hydrogen charging apparatus having a connection portion configured to be detachably connected to the charging/discharging opening, and configured to charge the fuel tank with hydrogen,
wherein the calculation unit is disposed in the hydrogen charging apparatus.

14. A hydrogen remaining level detection system according to claim 13, wherein the calculation unit is configured to calculate the amount of hydrogen charged by the hydrogen charging apparatus based upon the information with respect to the positions of both ends of the plurality of pellets along the layering direction detected by the detection unit,
and wherein the storage unit is configured to calculate the sum of the amount of charged hydrogen thus calculated and the cumulative charging amount stored in this stage, and to store the calculation result as an updated cumulative charging amount.

15. A fuel cell system comprising:
a fuel cell unit;
a fuel tank according to claim 1, configured to store hydrogen to be supplied to the fuel cell unit; and
a calculation unit configured to calculate the remaining level of hydrogen stored in the housing unit based upon a signal output from the detection unit.

16. A fuel cell system according to claim 15, wherein the fuel tank further comprises:
a charging/discharging opening configured to allow charging with hydrogen from the outside, and discharging of hydrogen to the outside; and
a storage unit configured to store information with respect to a cumulative amount of charged hydrogen.

17. A fuel cell system according to claim 16, wherein the calculation unit is configured to calculate the remaining level of hydrogen stored in the housing unit based upon the information with respect to the cumulative charging amount stored in the storage unit and the positions of both ends of the plurality of pellets along the layering direction detected by the detection unit.

18. A fuel cell system according to claim 16, further comprising a display unit configured to display the information with respect to the remaining level of hydrogen stored in the housing unit calculated by the calculation unit.

19. A fuel cell system according to claim 16, wherein the fuel cell unit is configured to be detachably connected to the fuel tank,
and wherein the calculation unit is disposed in the fuel cell unit.
